(19) United States
(12) Patent Application Publication
(10) Pub. No.: US 2016/0203650 A1
(43) Pub. Date: Jul. 14, 2016

(54) VALET SERVICE APPARATUS AND METHOD

(71) Applicant: VGO, LLC, Bear, DE (US)

(72) Inventor: Sam STANFORD, Bear, DE (US)

(21) Appl. No.: 14/596,444

(22) Filed: Jan. 14, 2015

(51) Int. Cl. G07B 15/02

(52) U.S. Cl. CPC G07B 15/02; G06Q 2240/00

(57) ABSTRACT

Methods and apparatus provide valet service for parking a car. A request is received to valet park the car of a user. The request is received wirelessly. Agreement to valet park the car is stored. The request or agreement is accompanied by identification information associated with the car. A database is maintained which includes the identification information. The database indicates if the car is valet parked responsive to the request from the user. A further request is received to retrieve the car which has been valet parked wherein the further request corresponds with the identification information associated with the car. Retrieval of the car is authorized responsive to receiving the further request and confirmation of the identification information in the database.

### FIELD OF THE INVENTION

The present invention relates to valet parking and more specifically to computer systems that facilitate valet parking In particular, a method and apparatus are disclosed for facilitating valet parking of a car and subsequent retrieval of the car.

### BACKGROUND OF THE INVENTION

When the driver of a car wishes to park a car, the driver may have the option of using a valet service. Typically, when using the valet service, the driver drives his or her car to an area where valet service is provided. The valet service is typically provided by a valet parking provider which may be a company, or a group of people (or employees) that provide valet services. An employee associated with the valet parking provider, typically called a valet, meets the driver and then takes the key from the driver. In return, the driver receives from the valet a receipt with a receipt number which will be matched with the driver's car. The valet then takes the driver's car, and parks the car. After a period of time, when the driver of the car is ready for his car to be returned, he hands the receipt to an employee of the valet service. The valet then confirms that the receipt number on the receipt is the same receipt number that has been assigned to the driver's car, obtains the key from a storage area, retrieves the car, and returns the car to the driver.

Use of a valet service is in contrast with self-parking in which a driver must find a parking spot, park the car himself, and then walk from the parking spot to his or her ultimate destination. Use of a valet service may be preferable to self-parking First, it may be difficult to find a location where the vehicle can be self-parked. In an urban environment, self-parking options may be severely limited. By contrast, when a driver uses a valet service, the valet service often has a reserved area where they may park the car. Second, self-parking can take a substantial amount of time. Not only might it take a long time to find a parking spot, but the parking spot might be a long distance from the ultimate destination. By contrast, when a valet service is used, the driver is able to simply get out of his car, hand over the key and receive the receipt from the valet. Third, use of a valet service can be significantly more convenient than self-parking. The valet service may be provided, for example, directly in front of the venue where the driver wishes to go. When a valet service is used, walking from a distant self-parking location to the ultimate venue can be eliminated.

There are numerous types of venues and locations which may offer valet service. Exemplary venues and locations include restaurants, hospitals, casinos, and one-time events, such as sporting events, celebrations, fundraisers, etc. The valet parking provider at any location can be a company that is independent from the venue where the car occupants ultimately desire to go, or it can be part of the company that owns the venue. Thus, for example, a restaurant may have its own valet parking provider or it may contract the work to an outside contractor.

Valet service can be offered to drivers on a free basis, or on a basis where the driver is not required to pay for the service (e.g. because the venue owner has paid for the valet service). When drivers are expected to pay for the service, while credit cards are sometimes accepted, payment often needs to be made in the form of cash. Sometimes the payment is made before the car is turned over to the valet parking provider. Other times, payment is made after the car is returned by the valet parking provider to the driver. Furthermore, payment may be made to the valet parking provider employee that actually returns the car to the driver.

### SUMMARY

Methods and apparatus provide valet service for parking a car. A request is received to valet park the car of a user. The request is received wirelessly. Agreement to valet park the car is stored. The request or agreement is accompanied by identification information associated with the car. A database is maintained which includes the identification information. The database indicates if the car is valet parked responsive to the request from the user. A further request is received to retrieve the car which has been valet parked wherein the further request corresponds with the identification information associated with the car. Retrieval of the car is authorized responsive to receiving the further request and confirmation of the identification information in the database.

In an exemplary embodiment of the present invention, payment is collected for valet parking the car.

In further embodiments of the present invention, a request to valet park a car of a user is wirelessly transmitted. The user wirelessly receives agreement to valet park the car, wherein the request or agreement is accompanied by identification information associated with the car. A further request to retrieve the car from being valet parked is transmitted, wherein the further request corresponds with the identification information.

In an exemplary embodiment of the present invention, payment is provided for valet parking the car.

### BRIEF DESCRIPTION OF THE DRAWINGS

FIG. 1 is a block diagram which illustrates an exemplary system for providing and/or obtaining valet service in accordance with an exemplary embodiment of the present invention.

FIG. 2 is a block diagram which provides exemplary details regarding a server system which may be used in accordance with an exemplary embodiment of the present invention.

FIG. 3a is a diagram which illustrates the logical formatting of one or more data structures which may be used in accordance with an exemplary embodiment of the present invention.

FIG. 3b illustrates the logical formatting of a further data structure which may be used in accordance with further exemplary embodiments of the present invention.

FIG. 4a is a block diagram which illustrates exemplary architecture of the user device which may be used in accordance with an exemplary embodiment of the present invention.

FIG. 4b is a block diagram which illustrates an app stored in the memory of a user device in accordance with an exemplary embodiment of the present invention.

FIG. 5 is a flow chart diagram which illustrates initialization steps for obtaining valet service in accordance with an exemplary embodiment of the present invention.

FIG. 6 is a flow chart diagram which generally illustrates steps which may be performed to obtain valet service in accordance with an exemplary embodiment of the present invention.

FIG. 7 is a flow chart diagram which provides more detailed steps for obtaining valet service in accordance with an exemplary embodiment of the present invention.

FIG. 8 is a flow chart diagram which illustrates steps for retrieving a vehicle from a valet parking provider in accordance with an exemplary embodiment of the present invention.

FIG. 9 is flow chart diagram which illustrates exemplary steps for providing valet service in accordance with an exemplary embodiment of the present invention.

FIGS. 10a, 10b and 10c are flow chart diagrams which illustrate, with more detail, steps for providing valet service in accordance with an exemplary embodiment of the present invention.

FIG. 10d is a flow chart diagram which illustrates, in accordance with a further exemplary embodiment of the present invention, additional steps which may be available for providing valet service in accordance with an exemplary embodiment of the present invention.

### DETAILED DESCRIPTION

While valet service provides convenience and other advantages to car drivers, there are disadvantages as well. For example, when a driver hands his key to the valet, the valet may park the car in a location only known to the valet without informing anyone else. When the car driver wishes to have his car retrieved, the valet can retrieve the car, return the car to the driver, and upon being paid simply keep the money. Through this type of theft, the valet parking provider would be deprived of the fees that they would normally collect for providing a valet service to the car driver. Furthermore, even if the valet legitimately parks the car through the valet parking provider, it is possible that the valet may forget where the car was parked. While employees of the valet parking provider attempt to find the car, the driver is subjected to inconvenience by having to wait for potentially a long period of time to receive his car. In addition, when drivers bring their cars to a valet parking provider, typically there is no warning that the car is arriving. Several cars can show up at one time with respective drivers seeking valet service. In that scenario, the valet parking provider has no idea that a large number of vehicles are about to appear that require valet service. Furthermore, because valet services have typically relied upon the use of cash and paper receipts, data regarding the business transactions that are incurring in conjunction with the valet service are not available in computerized form in real time. Thus, it may be difficult for management or ownership of a valet parking provider to know or have accurate records regarding the valet services being provided.

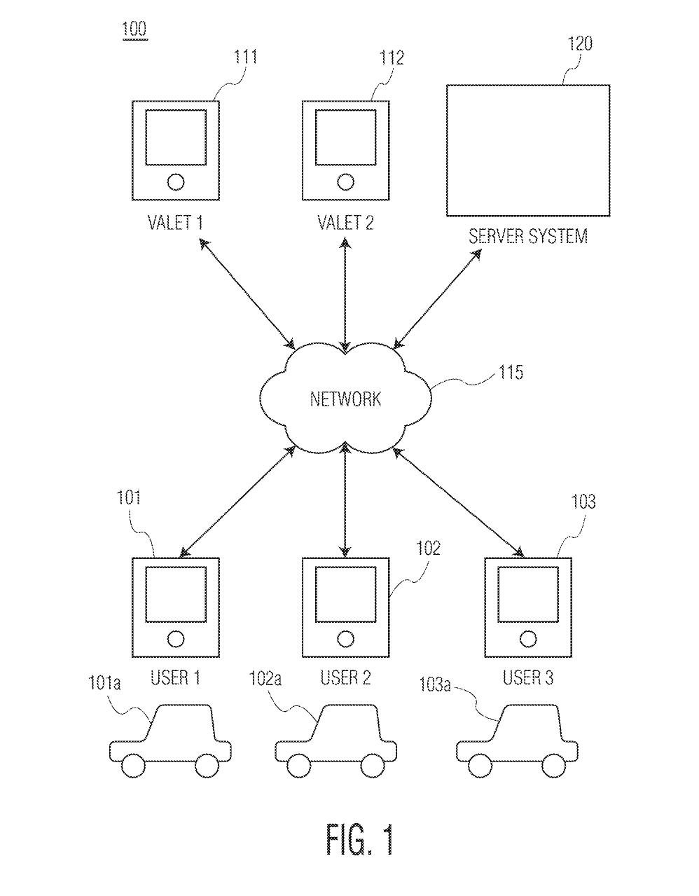

FIG. 1 is block diagram which illustrates an exemplary embodiment of the present invention. As shown in FIG. 1, there are a plurality of cars 101a, 102a, 103a with respective users that wish to have their cars valet parked. A “user” (such as User 1, User 2 and User 3 as shown) can refer to a person (such as a driver or a passenger in a vehicle) who wishes to have the vehicle valet parked. “User” can also refer to a computer device that is capable of requesting valet parking of a vehicle on an automated basis. Each user has a respective user device 101, 102 and 103. Each user device 101, 102 and 103 may be a smart phone, which has, for example, cellular and Wi-Fi capability. User devices 101, 102 and 103 communicate with network 115 using, for example, cellular or Wi-Fi connectivity. Thus, network 115 may be a cellular or Wi-Fi network. Server system 120 communicates with network 115. Server system 120 may perform back end processing for an exemplary embodiment of the present invention and will be described later. Communication between server system 120 and network 115 may be, for example, a high speed connection (wired, wireless, satellite, etc.) which would preferably provide high speed communication to, for example, users 1, 2 and 3. Each valet may also have access to their own user devices 111, 112. User devices 111, 112 can also communicate with network 115 using, for example, cellular and/or Wi-Fi connectivity.

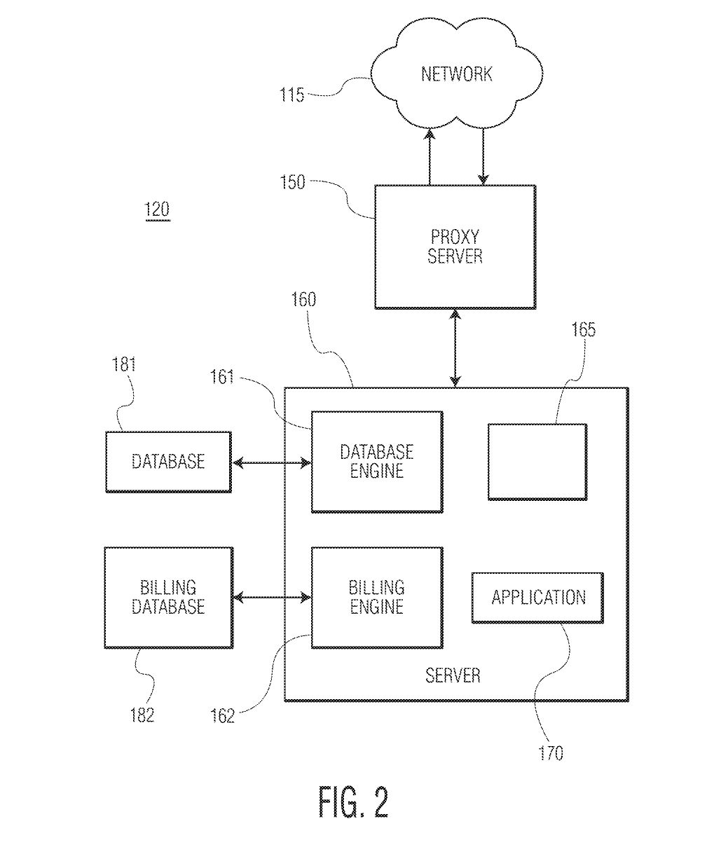

FIG. 2 is a block diagram which illustrates details regarding server system 120. Server system 120 may provide a cloud-based back end service to apps which are installed on user devices 101, 102, 103, 111, and 112. Thus, while user devices 101, 102, 103, 111, 112 are providing front end services, server 120 may be providing cloud-based back end services. When any of user devices 101, 102, 103, 111, 112 generate a request, the request may be transmitted via network 115 to proxy server 150. Proxy server 150 includes an authorization/authentication/accounting (AAA) engine (not shown) which may perform authentication and authorization. After authentication is successfully completed, proxy server 150 may communicate with server 160. Server 160 may include various engines such as database engine 161 and billing engine 162. After proxy server 150 transmits the request to server 160, application 170 can process the request and then return a proper response to the appropriate user device via proxy server 150. Application 170 is capable of accessing database 181 via database engine 161. Furthermore, a billing database 182 may be optionally included. Application 170 is capable of accessing billing database 182 via billing engine 162. Database engine 161 and billing engine 162 are both microprocessor base controlled. Implementation of application 170 may be accomplished using, for example, Azure Mobile Services and is understood by one of ordinary skill in the art. As an alternative, for example, proxy server 150 may be omitted and authentication may be performed on server 160. Database 181 and billing database 182 may be any form of memory (hard drive, solid state, etc.)

The above configuration is merely exemplary and it is understood by one of ordinary skill in the art that the present invention can be implemented with other structures as well.

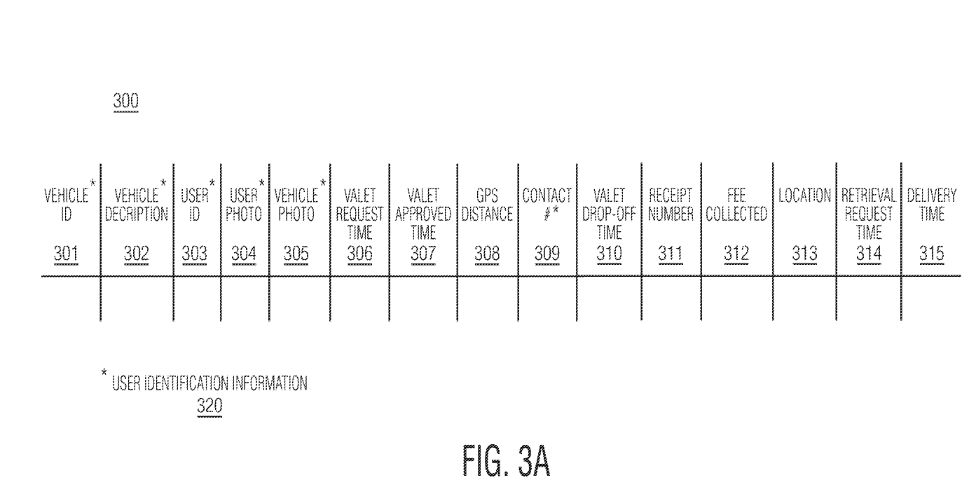

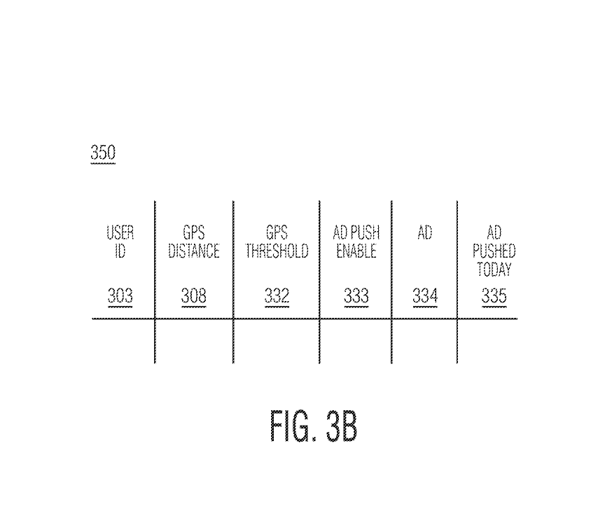

FIG. 3A is a diagram which illustrates the logical arrangement of data in database 181. The data structure 300 shown in FIG. 3A is stored in database 181 and is merely exemplary and is illustrative of the types of information which may be used in order to implement an exemplary embodiment of the present invention. It is understood by one of ordinary skill in the art that, depending upon the embodiment, some of the fields shown in FIG. 3A may be omitted. In addition, it is understood by one of ordinary skill in the art that further data fields may be desirably included in order to implement an exemplary embodiment of the invention.

Vehicle ID 301 may be a numerical (or alphanumerical) value which uniquely identifies a vehicle which is being valet parked. Vehicle description 302 may include any type of description of the vehicle such as make, model, color, etc. User ID 303 may be an alphanumeric data value which identifies a user which is using the valet service. User IDs are well known in the art and include names, initials, email addresses, unique numerical identifiers, etc. User photo 304 may be a picture of the user and may be used to help identify the user when the user is a driver dropping off his car for valet service or retrieving his car from valet service. Vehicle photo 305 may be a photograph of the vehicle which is being (or has been) valet parked. Valet request time 306 is the time at which the user is initially requesting valet parking Valet approved time 307 is a time at which, after a user has requested valet parking, the user's request for valet parking has been approved. GPS distance 308 is a distance of the vehicle from being dropped off for valet service and may be obtained from GPS location data. Contact number 309 is a cell phone number or email address (for example) of the user who is using the valet service. Valet drop-off time 310 is the time at which a user drops off his car for valet service. Receipt number 311 is the number of a receipt which is given to the user and which the user desirably provides when wishing to retrieve his car. Fee collected 312 indicates the amount of the fee which is collected from the user for using the valet service. Location 313 indicates a location where the user's car is parked by the valet service. Pickup request time 314 is the time at which the user initially request that his car be retrieved from the valet service so that the user can take repossession of his car. Delivery time 315 is the time that the car has actually been returned to the user.

While the above information is stored in database 181, it is understood that all information related to billing (i.e. fees, credit card information, etc.) may be stored in billing database 182.

Vehicle ID 301, vehicle description 302, user ID 303, user photo 304, vehicle photo 305, and contact number 309 (or parts thereof) may be collectively referred to as user identification information 320.

The various time values in data structure 300 may be set to a null value (e.g. XX: XX) to indicate that the action associated with that time has not yet occurred.

The use of the various fields of data structure 300 are more fully described below.

FIG. 3B illustrates a further exemplary data structure 350 which may be used in accordance with an exemplary embodiment of the present invention. User ID 303 which previously appeared in FIG. 3A is shown again for illustrative purposes. Furthermore, GPS distance 308 is again shown. As previously stated, GPS distance is the distance of a vehicle from being dropped off for valet service. GPS threshold 332 provides a distance (which may be, for example, predetermined) between the car and a valet service at which certain actions occur. Thus, when a certain vehicle is within a certain distance of the valet service, certain actions may occur which may be optional and which are described below. For example, if the vehicle is within a certain distance of the valet service, advertisement 334 may be pushed (i.e. transmitted) to the user via user device 101. Ad push enable 333 may be in a “yes” or a “no” state and indicate whether advertisement 334 is to be pushed towards the user once the GPS threshold has been met. Ad Pushed Today 335 indicates whether in the current day an ad has already been pushed to the user. This field can be checked before an ad is pushed to a user to ensure that the user is not inundated with ads (by receiving more than one ad per day).

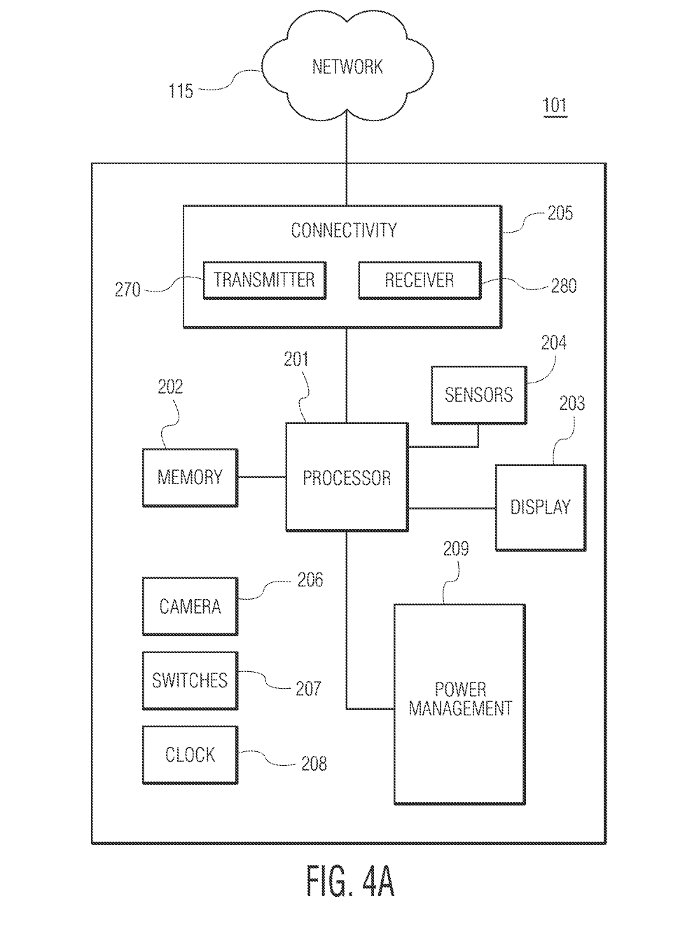

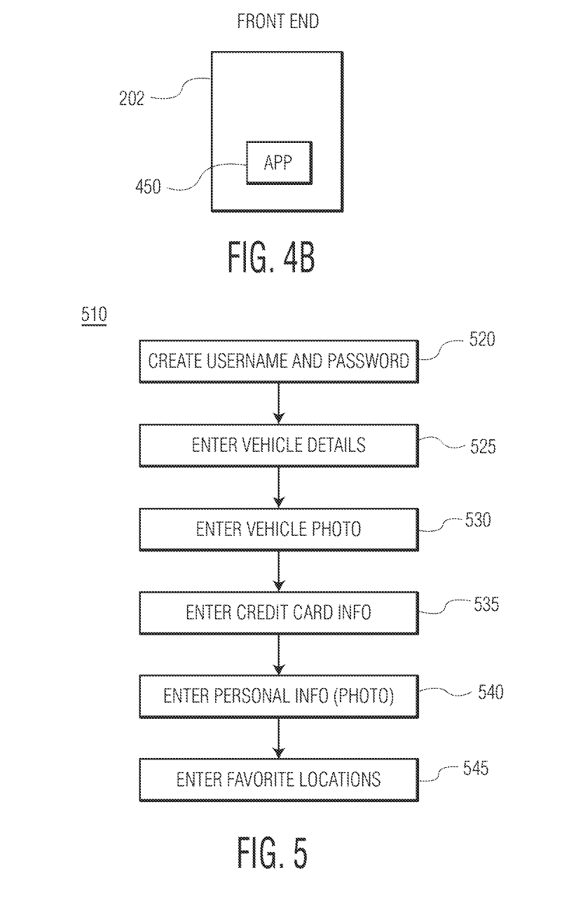

FIG. 4A is a block diagram which illustrates exemplary hardware included in user device 101. User device may be a mobile device such as a smart phone (such as an Apple iPhone or Samsung Galaxy). User devices 101, 102, 103 may be operated by drivers of cars (i.e. customers of a valet service). User devices 111, 112 may be similar smart phones and may be operated by employees of the valet parking provider. The block diagram shown in FIG. 4A is merely exemplary of a computer-based system (e.g. a smartphone) which may be used. The exemplary computer system shown in FIG. 4 includes microprocessor 201 which is able to access memory 202. Processor 201 is able to display information on display 203 which may also have touchscreen capabilities. Camera 206, switches 207, and clock 208 may also be included. Power management 209 is used for powering and recharging the device with batteries and an outside source of electricity. Sensors 204 can include accelerometers, GPS sensors, etc. Connectivity module 205 enables processor 201 to communicate with network 115. Connectivity module 205 may include the ability to communicate using cellular, Wi-Fi, Bluetooth and NFC (for example) As such, connectivity module 205 includes respective transmitter(s) 270 and receiver(s) 280 for receiving and transmitting data. FIG. 4A is merely exemplary of how a smartphone may be designed.

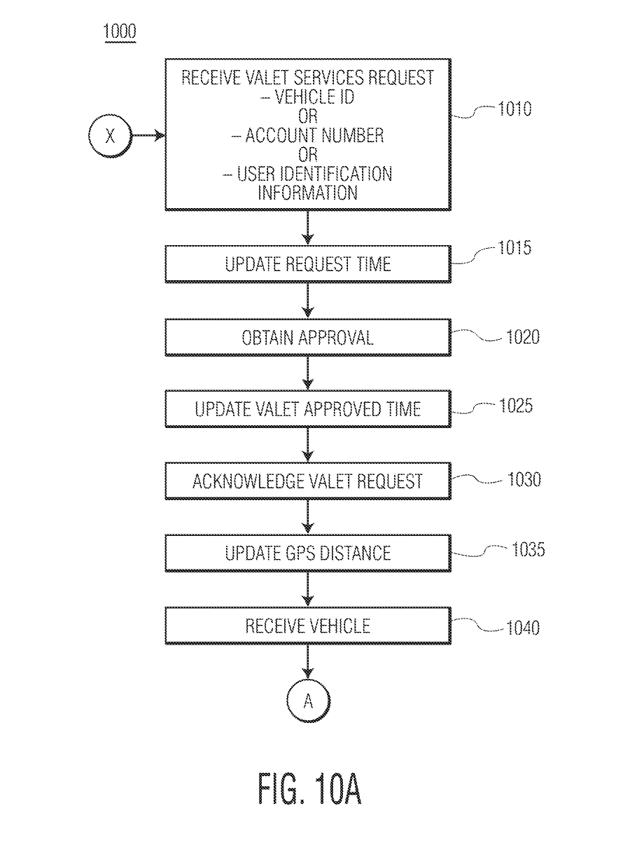

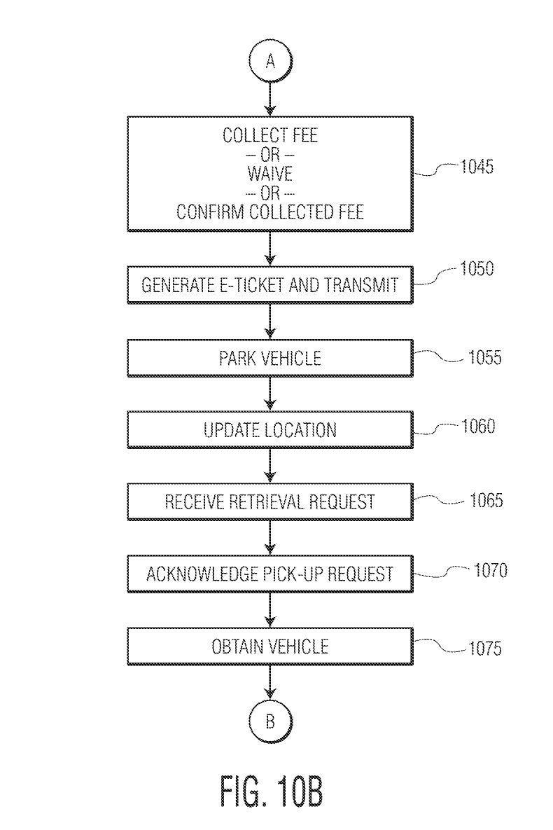

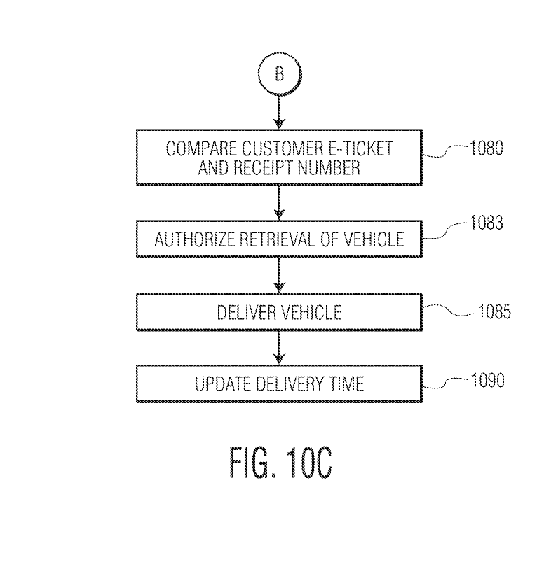

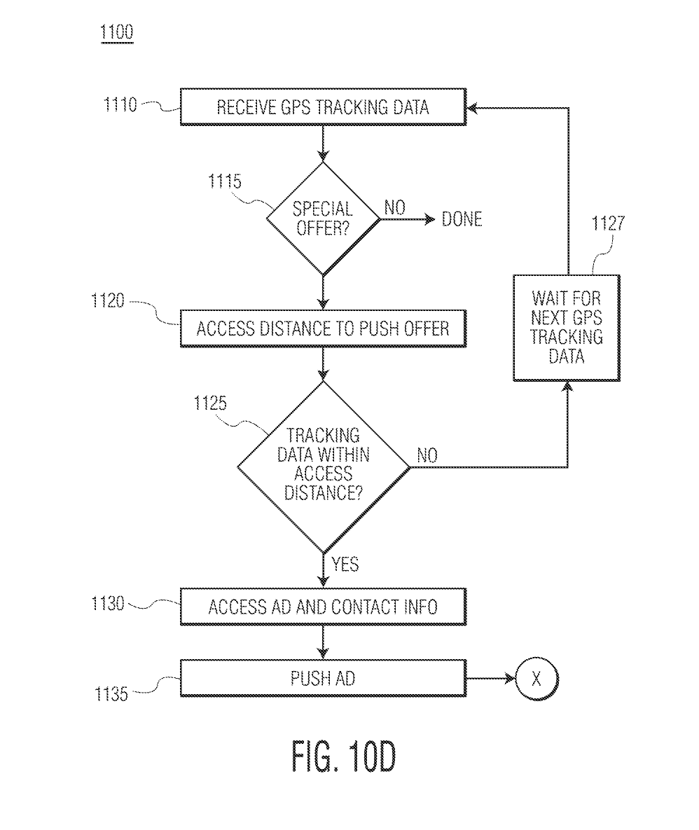

FIG. 4B illustrates memory 202 of user device 101 from a system perspective. Memory 202 of user device 101 includes app 450 which is the front end of an application. App 450 which is included in user devices 101, 102, 103 may be different than app 450 which is included in user devices 111, 112. This is because user devices 101, 102, 103 perform different functions than is performed by user devices 111, 112. User devices 101, 102, 103 are used by users who wish to park and subsequently retrieve their cars. User devices 111, 112 are used by valets who park cars for users and later retrieve those cars for those users. User devices 101, 102, 103 may be used with exemplary embodiments associated with, for example, FIGS. 5, 6, 7, and 8. User devices 111, 112 may be used with exemplary embodiments associated with FIGS. 9 and 10A-D. Further details regarding app 450 are provided below.

FIG. 5 is a flowchart diagram which illustrates the steps performed by user one, user two, and user three operating user devices 101, 102, 103, respectively. The steps shown in FIG. 5 are the steps which are used (possibly in order) to initialize the operation of an exemplary embodiment of the present invention. These steps may be performed by using an app, for example, which has been downloaded to user device (smartphone) 101. At step 520, the user creates a username and password. At step 525, the user enters vehicle details, such as make, model and color. At step 530, the user enters a photo of his vehicle. The photo may be obtained, for example, by using the camera function of a smart phone. At step 535, credit card information is entered. At step 540, personal information is entered. By referring to personal information, what may be included is a photograph of the user that wishes to use valet service. At step 545, the user enters favorite locations. These are locations where the user might be using valet services in the future. The favorite locations can be entered in conjunction with a map smart phone app. Alternatively, the locations can be selected from a plurality of locations that are included in the app at the time that the app is downloaded from a server. Each location may have corresponding communication information (i.e. a respective web address) corresponding to each location with which the smartphone communicates when obtaining valet services. Furthermore, additional locations may be added into the app, when, for example, the app itself is updated or the app receives additional data.

It is understood that the features referred to above and illustrated by FIG. 5 may be optional. Thus, for example, the user may not wish to input credit card information. The lack of credit card information may be, for example, because the user is only parking his car with valet services that do not charge drivers for the service. Alternatively, the user may be using a valet service that does not collect payment information until after the user retrieves his car from the valet service. In other examples, the user may not have favorite locations. In still further examples, the user may not wish to submit a photo of a car or of himself. Thus, it is understood that some (or perhaps all) of the data disclosed above may not be provided by the user.

When the user is entering data into user device 101, 102, 103, the user is entering the data into app 450. App 450 may be obtained through a publicly available App Store and may also be referred to as a client-side application. Thus, this client-side application 450 ultimately communicates with server-side application 170.

Creating a client-side app is performed using well-known languages such as Swift or Objective-C and is well known to one of ordinary skill in the art. Furthermore, there are publicly available books which provide significant information regarding development of smart phone apps. Exemplary publicly available books include “Navigating Xcode 5—iOS App Development for Non-Programmers: The Series on How to Create iPhone & iPad Apps”, Kevin J. McNeish (2012); “Flying with Objective-C—iOS App Development for Non-Programmers: The Series on How to Create iPhone & iPad Apps” Kevin J. McNeish (2013) and “Diving Into iOS 8—iOS App Developmemt for Non-Programmers Series: The Series on How to Create iPhone & iPad Apps”, Kevin J. McNeish (2014). All of the above books are hereby incorporated by reference for their teachings in the art of creating smart phone apps.

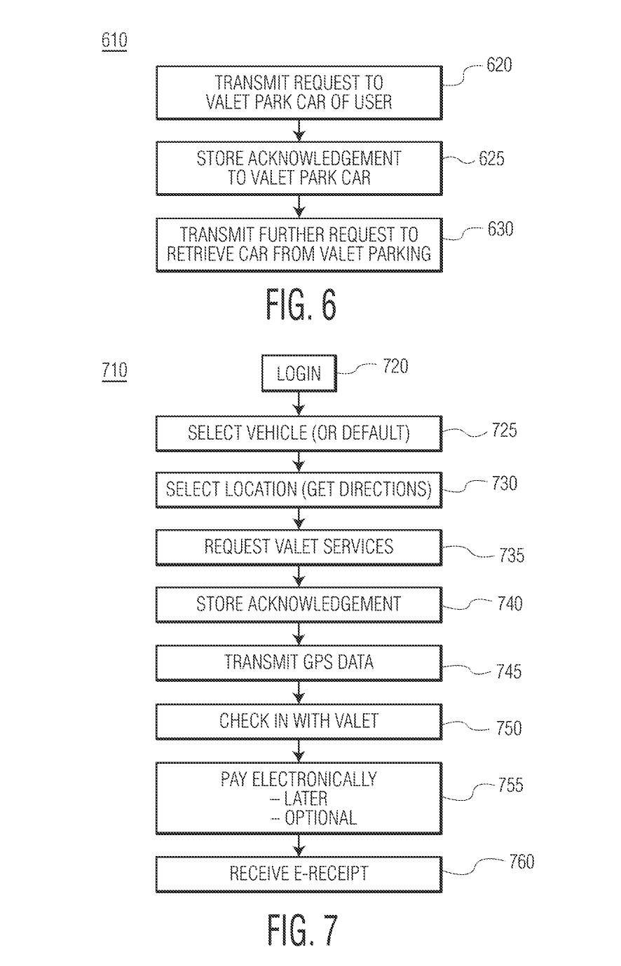

FIG. 6 is a flowchart diagram which illustrates an exemplary embodiment of the present invention relating to a user requesting valet services. FIG. 6 illustrates very general steps related to a user making such a request. In actuality, and in some embodiments, more steps may be performed as exemplified below. However, FIG. 6 illustrates several minimal steps relating to a user requesting valet services to park his car.

At step 620, a request to valet park the car of a user is transmitted. At step 625, an acknowledgment to valet park the car may be stored. At step 630, and at a later time, a further request to retrieve the car from valet parking is transmitted.

FIG. 7 is a further flowchart diagram of an exemplary embodiment of the present invention relating to the obtaining of valet services. FIG. 7 illustrates steps which may be included (or may not be included) in the exemplary embodiment illustrated by FIG. 6. It should be understood, however, that all of the steps shown in FIG. 7 are not required and at least some of the steps shown in FIG. 7 are optional.

At step 720, a user who wishes to obtain valet parking services logs in to his account. As previously explained, this may be done via user device 101 which is running app 450 in accordance with an exemplary embodiment of the present invention. The app may include a user interface (UI) which is used to facilitate entry of data by the user. Furthermore, when using the term “user,” what is intended is an individual or a computer system which desires to have the car valet parked. The individual can be the driver or a passenger. The computer system can be, for example, a computer system included in the vehicle which possibly has been previously advised of the destination of the vehicle or automatically requests valet parking of the vehicle based on the proximity of the vehicle to a specific valet parking location.

At step 725, the vehicle to be valet parked is selected. This step, however, is an optional step because a vehicle may be selected by the app by default.

At step 730, a location at which the valet parking is to occur is selected. The selection may occur in several different manners. One way for the selection to occur is that the user is provided with several locations and the user selects one of those locations for valet parking. In another scenario, the selection is available from GPS coordinates after the user has entered the address into a GPS system and the GPS system has identified that location. In yet another scenario, the vehicle is within a certain distance of a location that offers valet parking and the user is prompted to proceed to that location for valet parking. Thus, the user may designate a distance from his vehicle, and a GPS system finds and offers to the user all valet parking options within that distance. In yet another scenario, the user has selected via the GPS unit a location which is within a predetermined distance inform his vehicle and the user is asked whether he would like to obtain valet parking from that location. In yet a further scenario, the location is selected from a list of favorites which are created when the user initializes the app.

After the user requests valet services at step 735, a request for valet parking services is transmitted from user device 101 to server 120. Thus, for example, the request may be received by server 160 and application 170 may provide back end processing of the request. In order to process the request, various types of data are transmitted from user device 101 to server 160. The data which is transmitted may include user identification information 320 and be stored in database 181 using the format which is illustrated in FIG. 3A. At the time that the valet parking services request is received, valet request time 306 may be updated to include the actual time that the valet parking services request was received. This may include changing the data in the valet request time 306 field from a null value (e.g. XX: XX) to the actual time that the request is made. Having received the request, server 160 may need to wait for that request to be approved. At the time that the request for valet parking services is approved, field 307 is updated to include the time at which the valet parking services request was approved.

Approving the valet parking services request can be performed manually, or automatically. In one exemplary embodiment, manual approval is performed by displaying a request (to valet park the car) on a screen and waiting for an employee of the valet parking provider to type an agreement (to valet park the car) into a keyboard which is coupled to the screen. The system can be some type of computer system (not shown) which is coupled directly to server 160 or it can be a further app which appears on a user device such as user device 111, 112. In another exemplary embodiment, server 160 can automatically approve the valet parking services request, or can first check optional fields such as parking capacity (i.e. whether it has been exceeded at a particular location), a user's credit history, etc. before approval is transmitted.

At step 740, if the user has been approved for valet parking, an acknowledgment is generated of that approval and the acknowledgment is stored. Storage of that acknowledgment may occur, for example, by updating valet approved time 307 to indicate the time that the valet services were approved. Alternatively, the acknowledgement may be stored on user device 101 that initiated the request for valet services. By stating that the acknowledgement is stored, what is included in the definition of “stored” is displaying the acknowledgment on the screen of user device 101.

At step 745, the GPS data for the vehicle that is to receive valet parking is transmitted to server 160. GPS data may be the GPS coordinates of user device 101 from which the request for valet parking services is being made. FIG. 3A shows that data structure 300 includes a data field for GPS distance 308. Thus, GPS distance 308 may include the distance of the vehicle from the valet parking provider. This distance may be stored in several ways. One way to store the distance is for user device 101 to transmit GPS coordinates and for server 160 to compare those coordinates with the location of the valet parking provider. Based on the location of the vehicle and the location of the valet parking provider, any off-the-shelf GPS system can calculate the distance between the two points. Alternatively, the location of the valet parking provider can be transmitted to user device 101 and user device 101 can calculate the distance between the two locations. In yet a further alternative embodiment, the GPS coordinates of the vehicle are stored in data structure 300 and server 160 is able to continuously calculate the distance between the valet parking provider and user device 101 based on the stored GPS coordinates.

At step 750, the user has reached the location of the valet parking provider and the user has checked in with the valet. The process of checking in includes the user typically providing the vehicle keys to the valet. In addition, by using user device 111, the valet is able to update data structure 300 to include the correct valet drop-off time 310.

At step 755, the user pays for the valet service. Payment can occur in several manners. In one exemplary embodiment, credit card information is pre-stored in the user's account and the credit card information is accessed in order to charge the credit card. In another embodiment, the user produces a physical credit card and the credit card is swiped. Swiping of the credit card can optionally occur using a credit card swipe device (such as Square) which is coupled to user device 111. In a further exemplary embodiment, payment does not occur at the time that the vehicle was being dropped off at the valet. Rather, payment is made at the time the vehicle is retrieved from the valet. In yet another embodiment, payment does not occur at all because the user is not charged at any time for use of the valet service.

At step 760, the user receives an e-receipt in return for having his car valet parked. The e-receipt may be transmitted from server 160 to the user device 101 using several methods, including within the app, as a text message, as an email, etc. The e-receipt is stored in receipt number 311 of data structure 300. If and when a fee is collected, the amount collected may be stored in fee collected 312 of data structure 300. Again, the fee collected 312 can include a wildcard value ($X.XX)to indicate that no fee is due or that the fee is due and has not yet been paid.

After the user has dropped off his vehicle with the valet service, the valet will park the vehicle. The vehicle may be parked at a location known to the valet service. The location can be stored, for example, in location 313 of data structure 300 using user device 111. Furthermore, location 313 can be viewed by a user device 111 at any time.

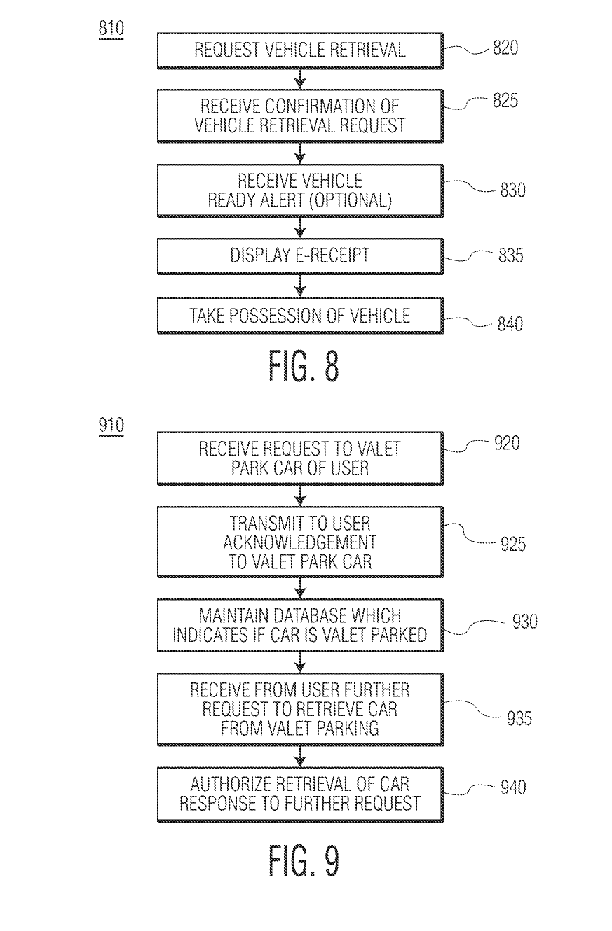

FIG. 8 is a flowchart diagram which illustrates exemplary steps that occur after the user is ready to receive his vehicle from the valet service. At step 820, using for example user device 101, the user requests retrieval of his vehicle via app 450. Retrieval request time 314 may be stored in data structure 300. At step 825, the user may receive confirmation of his vehicle retrieval request via user device 101. The confirmation may optionally include the time at which the retrieval request was received. At step 830, the user can receive an alert that his vehicle is ready for pickup. This step is optional. At step 835, the user displays his e-receipt to the valet. In one exemplary embodiment, the valet scans the e-receipt with a barcode scanner in order to read the e-receipt. The read e-receipt can be compared with receipt number 311 and data structure 300 to confirm that the receipt number is correct. Also, at that time, delivery time 315 can be updated to include the actual time that the vehicle is being delivered to the owner.

FIGS. 7 and 8 illustrate exemplary embodiments of the present invention from the perspective of the user requesting valet services using, for example, user device 101. Further exemplary embodiments of the invention, however, include the methods and apparatus which relate to the valet parking provider. Thus, FIG. 9 is a flowchart diagram which illustrates various steps which may be performed by the valet parking provider. FIG. 9 provides in general terms the steps which may be performed by the valet parking provider.

At step 920, server 160 receives a request to valet park the car of a user. This request can take several forms. In one embodiment, server 160 receives an identification number which may be associated with user identification information 320 (or portions of user identification information 320). In another embodiment, server 160 may receive other information in order to initiate the request for valet parking For example, server 160 may receive vehicle ID 301 with or without other information. Furthermore, (or alternatively), server 160 may receive user ID 303 (with or without other information).

Based on the information that server 160 receives at step 920, server 160 begins to populate various data fields within data structure 300. Data fields which may be populated include vehicle ID 301, vehicle description 302, user ID 303, user photo 304, vehicle photo 305, and/or valet request time 306. It should be understood that some or all of this information may have been pre-stored in database 181. In another exemplary embodiment, some or all of this information is first provided to server 160 and stored on database 181 at the time that the request to valet park the car is initially received. The request may then go through an approval process and an acknowledgment to valet park the car may be transmitted to the user. This occurs at step 925. As previously indicated, approval may occur automatically or it might require manual input of data through, for example, user device 111.

At step 930, database 181 maintains an indication of if and when the car has been valet parked. This indication may consist of, for example, entering the valet drop-off time in valet drop-off time 310, entering the receipt number in receipt number 311, etc. Again, these fields can have null values and can then be populated with actual values to indicate that the car has indeed been valet parked. At step 935, a request to retrieve the car from valet parking is received from the user, the retrieval request time 314 can be updated when this action occurs. Retrieval of the car responsive to the request can then be authorized step 940. This may occur, for example, by signaling user device 111 that a valet should go retrieve the car (and optionally providing the location where the car is parked).

A more detailed explanation of exemplary embodiments of the invention relating to the valet parking provider will now be discussed with reference to FIGS. 10A, 10B and 10C. It should be understood that the steps which are illustrated in those figures are merely exemplary and, in alternative embodiments, the order of the steps can be changed from what is shown. In addition, several of the steps which are shown may be optional.

At step 1010, server 160 receives a request for valet services. In actuality, several steps may occur prior to step 1010 in certain exemplary embodiments and one such exemplary embodiment is illustrated by the off page connector x. The features related to the exemplary embodiment which precedes step 1010 via off page connector x are illustrated, for example, in FIG. 10D and will be discussed later.

Returning to FIG. 10A, the valet services request is received by server 160, and it may be received wirelessly. The valet services request may include various types of information and in each exemplary embodiment, different types of exemplary information are contemplated. Thus, for example, the valet services request can be accompanied by a vehicle ID, and/or an account number, and/or user identification information. The account number can be associated with any or all of the user identification information. Furthermore, any or all of the user identification information could have been previously stored in database 181, and the valet services request may be nothing more than a valet services required based on the previously stored user identification information. Alternatively, any or all of the user identification information can be transmitted to server 160 at the time that the valet services request is transmitted.

At step 1015 valet request time 306 is updated to include the time that the valet services request is received.

At step 1020, approval for the valet services request is obtained. Again, as previously described, this may occur automatically, via input to a computer device which is connected in a wire or wireless form to server 160 or via a user device such as user device 111.

Once the valet services request has been approved, valet approved time 307 is updated at step 1025 to include the time at which the valet services request was approved. Updating valet approved time 307 is one way to store agreement (approval) to valet park the car, but it is understood that there are other ways (such as an optional data field in database 181) to store the agreement within database 181. At step 1030, the valet request can be acknowledged. This acknowledgment can occur, for example, by signaling user device 101. User device 101 can be signaled and the acknowledgement can appear within the app (using cellular or Wi-Fi data), or via some other form of communication such as email or text messaging. The acknowledgement can also (or alternatively) include user identification information.

At step 1035, GPS distance 308 is updated. As previously described, GPS distance 308 is based on calculating the distance between the current coordinates of user device 101 within the car which is being valet parked (i.e. as the car is being driven to the location where valet parking occurs) and the coordinates of the location where the valet parking occurs. Many off-the-shelf GPS units are able to calculate distance between two locations based on the GPS locations based on the GPS data associated with each location. As the vehicle comes closer to the valet parking service, the valet parking service can be apprised of the imminent arrival of the vehicle. This can be accomplished, for example, by providing regular updates to user device 111 of the distance between the vehicle and the valet service. Alternatively, user device 111 can be signaled an alert when the distance between the vehicle to be valet parked and the valet service provider is below a predetermined threshold.

At step 1040, the valet services provider receives the vehicle from the user who requested the valet parking services. The time that the vehicle is dropped off with the valet can be stored in valet drop-off time 310.

Processing continues to FIG. 10B via off page connector A.

At step 1045, the fee for valet parking may be collected. As previously explained, the fee may be collected by charging a pre-stored credit card number or by requesting that the user swipe a credit card at a credit card terminal, by entering a credit card number into user device 101, user device 111, etc. In some exemplary embodiments of the present invention, the fee may not be collected until after the vehicle is returned to the user. In further exemplary embodiments, the fee is waived and the user is not charged for the valet parking If and when the fee is collected, the amount of the collected fee may be stored in fee collected 312 of data structure 300.

At step 1050, an e-ticket is generated by server 160 and transmitted to the user (via cellular data, wifi data, text messaging, email, etc.). The user can see the e-ticket on, for example, user device 101. The e-ticket includes a receipt number. The receipt number is stored by the valet parking provider and is desirably matched with the e-ticket in the possession of the user before the valet parking provider returns the car to the user. The receipt number is stored in receipt number 311 of data structure 300. At step 1055, the valet parks the vehicle and at step 1060, location 313 is updated to include the location where the vehicle has been parked. The valet may enter this location in location 13 via user device 111.

At a later time, at step 1065, server 160 receives a request for the vehicle to be retrieved. The request is accompanied by at least some of the user identification information, the recipt number, or some other way to identify the vehicle that is requested to be retrieved. Server 160 then transmits an acknowledgment that the pickup request has been received. Transmission of the acknowledgment can include updating retrieval request time 314 to include the time that retrieval was requested. At step 1075, a valet obtains the vehicle and brings the vehicle back to the user.

Processing continues in FIG. 10C via off page connector B. At step 1080, the customer e-ticket and receipt number 311 are compared. This comparison can occur by viewing the e-ticket on user device 101 and the receipt number on user device 111 which may be obtained from database 181 (via server 160). Alternatively, the e-ticket on user device 101 can be scanned via user device 111 (or manually entered into user device 111) so that the comparison of the e-ticket and the receipt number can be more automated. It is thus contemplated that another method of authorizing return of the vehicle to the user is for the e-ticket on the user device to be transmitted to server 160, and for server 160 to compare the e-ticket and the receipt number to confirm that they have the same information, and to then signal user device 111 that the return of the vehicle to the user is authorized. If the two numbers match, then, the match is communicated to user device 111 and at step 1085 the vehicle is returned to the user. Delivery time 315 is then updated in step 1090 to include the time that the vehicle was delivered to the user.

A further exemplary embodiment of the present invention is illustrated by FIG. 10D. At step 1110, server 160 receives GPS tracking data from user device 101. Thus, server 160 is able to determine the proximity of user device 101 to any valet parking provider for which server 160 has the respective GPS coordinates. If user device 101 is within a predetermined distance from a valet parking facility, the intention is to provide the user with an incentive to use that valet parking facility even though use of the valet parking facility was not originally contemplated. Thus, for example, at step 1115, server 160 determines whether a valet parking provider is within a predetermined distance to user device 101 (to thus incentivize a user to use that valet parking provider).

Assume, for example, that user device 101 is within 1 mile of the restaurant Fogo de Chao. The user can then be sent a message inviting the user to have dinner that evening at restaurant Fogo de Chao. Furthermore, the user may be incentivized to have dinner at Fogo de Chao by providing the user with some discount or advising the user of some special prices in effect for that evening. If no such offers are available, or incentivizing the user with the venue within a predetermined distance of user device 101 is not in place, then the “no” branch of step 1115 is executed and no further steps are taken. However, if it is desired to incentivize the user to go to a certain venue (location), and, at step 1120, the distance between user device 101 and the certain venue is accessed. At step 1125 it is determined whether user device 101 is within the predetermined distance of the venue (also referred to as the access distance). If user device 101 is not within the predetermined distance, then processing proceeds to step 1127 in which server 160 waits for further GPS tracking data from, for example, user device 101. If, however, user device 101 is within the predetermined distance, the processing proceeds to step 1130 at which an ad for the venue will be “pushed” to user device 101. At step 1135, the ad is pushed to the user so that the ad may appear on user device 101. Processing then proceeds to step 1000 in FIG. 10A via off page connector x. At step 1010, again, the request for valet services is received.

The “predetermined distance” can be stored (or changed) within database 181 (for example). The predetermined distance may be read from database 181 and compared with the distance that user device 101 is away from a location where valet parking is available (based on GPS data received from user device 101). Thus, when user device is within the predetermined distance, an ad corresponding to the location where valet parking is available can then be pushed to user device 101.

FIG. 3B illustrates data structure 350 which may be separated or may be part of data structure 300. Data structure 350 may also include user ID 303 from data structure 300. Data structure 350 may also include GPS distance 308 which is the distance between user device 101 and a valet parking provider. GPS threshold 332 can be pre-stored with the distance between user device 101 and the parking valet provider at which the ad described above may be pushed to the user. Ad push enable 333 controls whether or not an ad is pushed to the user when the GPS threshold 332 has been crossed. The ad to be pushed to the user may be stored in ad 334. Ad push today 335 indicates whether an ad for a particular venue has already been pushed to a user on a particular day. In this way, if the user is traveling along the fringe of the area within which an ad is pushed to the user, the user is not pushed a particular ad more than once in one day.

As explained with reference to FIG. 4A, connectivity module includes transmitter 270 and receiver 280 for transmitting and receiving data using one or more communication protocols. As such, transmitter 270 may, in some exemplary embodiments, be considered to be a valet parking requestor because it is capable of transmitting the request to network 115 to valet park the car. Transmitter 270 is also capable of transmitting identification information associated with the car. Receiver 280 may, in some exemplary embodiments, be considered to be a valet parking receiver because it is capable of receiving agreement (or acknowledgement) to valet park the car. Transmitter 270 and receiver 280 are part of connectivity module 250 of a smartphone and may be understood and implemented by one of ordinary skill in the art of smart phone design.

While the present invention has been described herein with reference to exemplary embodiments, it should be understood that the invention is not limited thereto. Those skilled in the art with an access to the teachings herein will recognize additional modifications, applications, and embodiments within the scope thereof and additional fields in which the invention would be useful.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnotogical storage device, etc.).

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of providing valet service for parking a car, said the method comprising the steps of:
receiving from a user a request to valet park the car of said user, said request received at a server over a network;
storing, in a memory device, agreement to valet park the car, wherein said request or said agreement is accompanied by identification information associated with the car, wherein said request and said identification information is stored in the memory device via a microprocessor controlled database engine included with said server;
maintaining in said memory device a database which includes said identification information, wherein said database indicates if said car is valet parked responsive to said request from said user;
receiving at the server and from the user a further request to retrieve the car from being valet parked, said further request corresponds with said identification information; and
authorizing retrieval of said car responsive to receipt of said further request and confirmation by said server of said identification information in said database.

2. A method of providing valet service for parking a car according to claim 1, further comprising the steps of:
valet parking the car of the user responsive to said request; and
returning the car to the user responsive to said further request.

3. A method of providing valet service for parking a car according to claim 1, further comprising the step of receiving indication that payment for valet parking of the car has occurred.

4. A method of providing valet service for parking a car according to claim 3, wherein said car is valet parked or retrieved responsive to receiving the indication that payment has occurred.

5. A method of providing valet service for parking a car according to claim 1, wherein said identification information includes an image of said car or of said user.

6. A method of providing valet service for parking a car according to claim 1, wherein said identification information is received from said user when the request to valet park the car of the user is received.

7. A method of providing valet service for parking a car according to claim 1, wherein location of said car while said car is valet parked is associated with said identification information and stored in said database.

8. Apparatus for providing valet service for parking a car, said apparatus comprising:
a microprocessor based server for wirelessly receiving from a user:
a request to valet park the car of said user;
a further request to retrieve the car from being valet parked.
a database which includes identification information associated with the car, wherein said server includes a database engine which modifies said database to indicate if said car is valet parked responsive to said request from said user;
said microprocessor based server includes a transmitter for wirelessly transmitting, to said user, agreement to valet park the car, wherein said request or said agreement is accompanied by identification information associated with said car.
an authorization unit for authorizing retrieval of the car responsive to receipt of said further request and confirmation by said server that said identification information in said database indicated that said car is valet parked.

9. Apparatus for providing valet service for parking a car according to claim 1, wherein said transmitter further:
signals that said car is approved for being valet parked; and
signals that said car is approved for being retrieved from being valet parked.

10. Apparatus for providing valet service for parking a car according to claim 1, wherein said receiver receives an indication that payment for valet parking of the car has occurred.

11. Apparatus for providing valet service for parking a car according to claim 1, wherein said identification information includes an image of said car or of said user.

12. Apparatus for providing valet service for parking a car according to claim 1, wherein said identification information is received from said user.

13. Apparatus for providing valet service for parking a car according to claim 1, wherein location of said car while said car is valet parked is associated with said identification information and stored in said database.

14. A method of obtaining valet service for parking a car, said method comprising the steps of:
transmitting using a wireless device a request to valet park a car of said user, said request transmitted wirelessly;
receiving on said wireless device, and by said user, agreement to valet park the car, wherein said request or said agreement is accompanied by identification information associated with the car which is stored in a memory of said wireless device;
wirelessly transmitting with said wireless device a further request to retrieve the car from being valet parked, wherein said further request corresponds with said identification information.

15. A method of obtaining valet service for parking a car according to claim 14, further comprising the steps of:
providing the car to be valet parked; and
receiving the car after the car has been retrieved from being valet parked.

16. A method of obtaining valet service for parking a car according to claim 14, further comprising the step of providing payment for the car to be valet parked.

17. A method of obtaining valet service according to claim 14, wherein said identification information includes an image of said car or of said user.

18. Apparatus for obtaining valet service for parking a car, said apparatus comprising:
a valet parking requestor which is included in a wireless device and which transmits a request to valet park the car and which transmits identification information associated with the car; and
a valet parking receiver included in said wireless device which receives agreement to valet park the car;
wherein said valet parking requestor further transmits a further request to retrieve the car from being valet parked, wherein said further request corresponds with said identification information.

19. Apparatus according to claim 18, wherein said identification information includes an image of the car or a user which transmits said request to valet park the car.

20. Apparatus according to claim 18, wherein said identification information is transmitted with said request to valet park the car.
